(19) United States
(12) Patent Application Publication
(10) Pub. No.: US 2026/0220829 A1
(43) Pub. Date: Jul. 30, 2026

(54) Automated Image Generation and Optimization

(71) Applicant: eBay Inc., San Jose, CA (US)

(72) Inventors: Yuri Brovman, Miami, FL (US); Nazmul Kabir Chowdhury, Nyack, NY (US); Jonathan Frank Galsurkar, New York, NY (US); Mengyi Li, San Francisco, CA (US)

(73) Assignee: eBay Inc., San Jose, CA (US)

(21) Appl. No.: 19/039,577

(22) Filed: Jan. 28, 2025

(51) Int. Cl. G06T 11/00; G06F 40/279; G06F 40/40; G06Q 30/0601

(52) U.S. Cl. CPC G06T 11/00; G06F 40/279; G06F 40/40; G06Q 30/0641; G06T 2200/24

(57) ABSTRACT

Automated image generation and optimization is described. In one or more implementations, a sample of listing titles is extracted from listings maintained by the online marketplace within a particular category. The extracted listing titles are simplified using at least one large language model (LLM) to remove extraneous information for image generation. An image prompt is generated using the LLM based on the simplified listing titles and the particular category. One or more images are generated using a large vision model based on the image prompt. The generated images are scored using a vision language model based on predefined criteria. The image prompt is iteratively refined based on the scoring, and images are regenerated until at least one image meets a threshold score for the predefined criteria.

### BACKGROUND

Online platforms rely heavily on visual content to showcase various items and categories, traditionally using manually curated images and banners. This approach, while effective for featured categories, faces scalability challenges when applied across a multitude of categories, e.g., hundreds or thousands of categories. The manual curation process is time-intensive, resource-demanding, and limits a platform's ability to swiftly update and diversify visual content in real-time as listings for new items are constantly added to the platform and listings are removed or hidden as items are purchased, continuously changing the composition of items in those categories.

### SUMMARY

In accordance with the described techniques, an image generation and optimization system extracts a sample of listing titles from a particular category of listings and simplifies the extracted listings using a large language model (LLM) to remove extraneous information. The system then generates an image prompt based on the simplified titles and respective category using an LLM. One or more images are created from this prompt using a large vision model. The system scores the generated images against predefined criteria using a vision language model. If none of those images meets a threshold score, the system iteratively refines the image prompt and regenerates images until at least one image meets the threshold score, indicating that such an image satisfies the criteria. The scoring criteria may include prompt fidelity, absence of flaws, image quality, and consistency with product photography style. The system may select high-engagement listings for the title samples (e.g., having a relatively high number of clicks and/or high click rate), remove non-visual details such as brand names and sizing during title simplification, and specify image subject, style and background in the prompt. Multiple images can be generated per prompt, and images that satisfy the predefined criteria can potentially be incorporated into the marketplace's user interface for the respective category.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of using a vision language model to iteratively evaluate generated images against predefined criteria and refine an image prompt to regenerate and improve the images.

FIG. 3 depicts an example of a user interface that incorporates an image generated by a large vision model where the incorporated image satisfies a threshold score for the predefined criteria.

FIG. 4 depicts a procedure in an example implementation of automated image generation and optimization.

FIG. 5 illustrates an example of a system generally that includes an example of a computing device which is representative of one or more computing systems and/or devices that may implement the various techniques described herein.

### DETAILED DESCRIPTION

### Overview

Conventional online marketplaces often rely on manually curated images and banners created by human content creators to showcase featured categories. This approach, while effective for a limited number of categories, faces significant challenges when applied across hundreds or thousands of product categories. The manual curation process is time-intensive, resource-demanding, and limits a platform's ability to swiftly update and diversify visual content. This limitation becomes particularly problematic in dynamic marketplaces where new listings are constantly added and existing ones are removed or hidden as items are purchased, continuously changing the composition of items in the various categories.

To address these challenges, multimodal large language models and artificial intelligence (AI) are leveraged to automate the generation and optimization of category-specific images. The improved approach begins by extracting a sample of listing titles from listings within a particular category of an online marketplace. These extracted titles are then simplified using a large language model (LLM) to remove extraneous information that might interfere with or be useless for image generation, such as brand names, size information, or model numbers.

Using the simplified listing titles and category information (e.g., the category name), an LLM generates an image prompt. This prompt is designed to capture the essence of the category and guide the creation of representative images by a large vision model. The large vision model then uses this prompt to generate one or more images. To ensure the quality and relevance of these generated images, a vision language model evaluates the generated images based on predefined criteria. These criteria may include, for example, the image's correspondence to the prompt, absence of flaws (e.g., hallucinations), overall quality and clarity, and consistency with defined product photography styles.

If the generated images do not meet a threshold score based on these criteria, the system enters an iterative refinement process. The vision language model refines the image prompt based on the original prompt, the images generated, and scoring results. The refined image prompt is used by the large vision model to generate new images. This cycle continues until at least one image meets the required threshold score. A resulting high-quality image can then be incorporated into a user interface for the corresponding category in the online marketplace.

This automated approach offers several advantages over conventional systems. It significantly reduces the time and resources required for creating category-specific images, allowing for rapid updates across a vast number of categories. The use of artificial intelligence models ensures consistency in image style and quality, while the iterative refinement process helps maintain high standards for visual content. Additionally, the system can adapt to changes in category composition in real-time, ensuring that the visual representation remains current and relevant.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

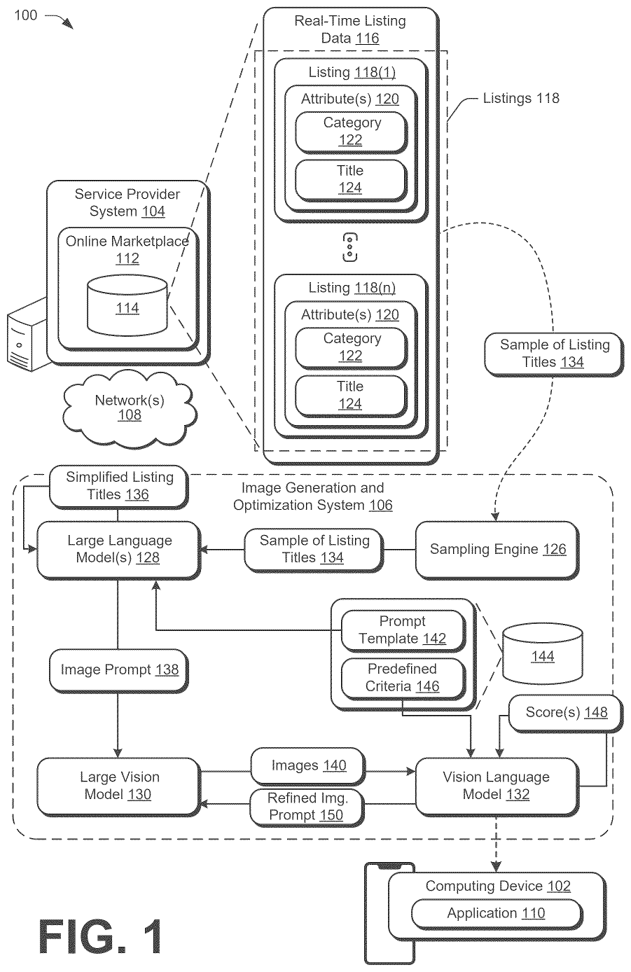

FIG. 1 is an illustration of an environment 100 in an example implementation that is operable to employ techniques described herein. The environment 100 includes a computing device 102, a service provider system 104, and an image generation and optimization system 106. In one or more implementations, the computing device 102, the service provider system 104, and the image generation and optimization system 106 are communicatively coupled, one to another, via network(s) 108. One example of the network(s) 108 is the Internet, although one or more of the computing device 102, the service provider system 104, and the image generation and optimization system 106 may be communicatively coupled using one or more different connections or different networks in various implementations.

Although the image generation and optimization system 106 is depicted in the environment 100 as being separate from the computing device 102 and the service provider system 104, in one or more implementations, an entirety or various portions of the image generation and optimization system 106 are implemented at or by the computing device 102 and/or the service provider system 104. In at least one implementation, for example, at least a portion of the image generation and optimization system 106 is implemented by an application 110 of the computing device 102 and/or using various resources of the computing device 102, such as hardware resources, an operating system, firmware, and so forth. Alternatively or additionally, at least a portion of the image generation and optimization system 106 is implemented by resources (e.g., server-based storage, processing, and so on) of the service provider system 104. Alternatively, or additionally, at least a portion of the image generation and optimization system 106 is implemented using a third-party service, such as a web services platform that provides one or more hardware and/or other computing resources to support provision of services by web service providers.

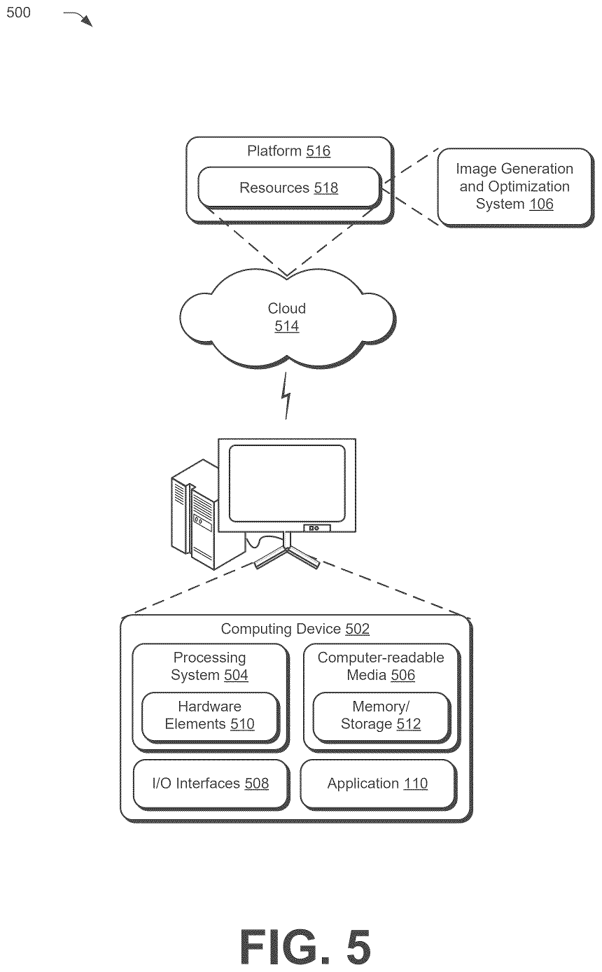

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 5.

In at least one implementation, the application 110 supports communication of data across the network(s) 108, such as between the computing device 102 and the service provider system 104 and/or between the computing device 102 and the image generation and optimization system 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112's website. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings for items and to expose those listings (e.g., publish them) across the network(s) 108 to one or more computing devices, including to the computing device 102. For example, the online marketplace 112 may generate listings for items for sale and expose those listings to computing devices, such that users of the computing devices can interact with the listings via user interfaces to initiate transactions (e.g., purchases, add to wish lists, share, and so on) in relation to the respective item or items of the listings. In accordance with the described techniques, the online marketplace 112 is configured to generate listings for one or more types of physical goods or property (e.g., clothing and/or clothing accessories, automotive, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, automotive repair and upkeep, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 includes storage device 114, which is depicted maintaining real-time listing data 116. The real-time listing data 116 includes listings 118 of the online marketplace 112. Examples of such listings include listing 118(1) and listing 118(n), where ‘n’ represents any integer number greater than or equal to 2.

The storage device 114 may represent one or more databases and/or other types of storage capable of storing the real-time listing data 116. Examples of the storage device 114 include, but are not limited to, mass storage and virtual storage. In one or more implementations, for example, the storage device 114 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed in to such an account or tracked as a user with an account.

In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items listed with the online marketplace 112 (e.g., the items that those users decide to list through the online marketplace 112) than the company associated with the online marketplace 112 (or its employees or legal agents).

Due to this, an inventory of the items listed by the online marketplace 112 may change constantly. Indeed, a next item listed by a user of the online marketplace 112 may be unknown to the online marketplace 112 until a user of the online marketplace 112 provides user input to describe and actually cause generation of a listing for the item. As items are added to the online marketplace 112 (e.g., listed for sale) and removed (e.g., purchased or taken down), the inventory of the online marketplace 112 and thus the real-time listing data 116 is ever changing. For example, many users of the online marketplace 112 may list items that are unique to the online marketplace 112, such that an item is “one of one” listed by the online marketplace 112. This contrasts with the listings of many retailers, which generally have more centralized control over their inventories and thus knowledge of the items being listed on their sites before the items are listed. Such retailers plan for the specific items being listed, such as by having a human content creator create engaging digital images for the retailer's website or mobile application. With the conventional approaches taken by many retailers, a buyer purchases a number of the same item and even same size, and a central (or at least controlled) authority causes those planned items to be listed. This enables those retailers to plan for and deploy digital content on their platforms that readily matches the available items.

By contrast, the ever-changing nature of an online marketplace 112 where decentralized users are capable of affecting the available inventory at any given time, such as by adding unknown items and/or causing various one-off items to be removed, provides a host of challenges. Where the online marketplace 112 supports a great many users (e.g., tens, hundreds, thousands, millions, etc.), for instance, it is impossible for a human to keep track of the inventory of items listed via the real-time listing data 116. This is particularly true because there are a great many listings for items and also because listings for a number of unknown items can be added at unpredictable times. As a result, conventional approaches for creating and configuring user interfaces of the online marketplace 112 to include engaging content, e.g., images, graphics, text, and so on, which accurately represents the items currently listed by the online marketplace 112, lack the speed to keep up with an inventory of items that is ever changing and in some cases is unpredictable due to a decentralized user base.

Users that cause items to be listed on the online marketplace 112 may be referred to as “sellers,” whereas users that purchase or otherwise obtain items listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items to be listed on the online marketplace 112 and by interacting with the user interfaces to browse and/or purchase one or more items from the listings of the online marketplace 112.

A user that is a seller, for instance, may interact with one or more user interfaces of the online marketplace 112 (e.g., output via the application 110) to provide information about one or more items which the user is causing to be listed on the online marketplace 112. Such user interfaces may include prompts that instruct, or guide, users that are sellers to provide various information about items being listed. Examples of information that such interfaces prompt sellers for and that those users provide include but are not limited a title, description (of the item), one or more prices (e.g., to purchase the item now and/or a minimum starting bid for the item), brand information, size, year, color(s), shipping information (e.g., cost and/or types available), delivery information, return information, payment information, images, videos, models, authenticity information, item history (e.g., chain of custody), and condition (of the item), to name a few.

One or more portions of such information may be referred to herein as attribute(s) 120 of the listing. For example, a title of the listing may be an attribute of the listing, a description of the item being listed may be an attribute of the listing, one or more images uploaded or selected for the listing may be one or more attributes of the listing, color(s) of the item may be an attribute of the listing, a category of the item may be an attribute of the listing, and so forth.

In one or more implementations, the online marketplace 112 saves and maintains the input information for a listing in the storage device 114 in fields of a data structure or data record populated for the listing, where a given field and the information populated and maintained for the given field correspond to a particular attribute of the listing. For instance, a ‘title’ field of such a data structure or data record may be populated with information (e.g., text) input into a user interface by a seller of a listing. The title field and the information input by the user as the title of the listing correspond to an attribute of the listing, e.g., a title attribute. In one or more implementations, one or more of the attribute(s) 120 of a listing may be derived and then populated by the online marketplace 112, such as by the online marketplace 112 processing one or more portions of the information input by a user to populate one or more respective attributes of the listing, e.g., using natural language processing and/or artificial intelligence.

In terms of notable attribute(s) 120 in the context of the described techniques, the listings 118 each include a category 122 attribute and a title 124 attribute. As used herein, the term “category” refers a grouping of related items, e.g., on the online marketplace 112. The use of categories is designed to help users (e.g., buyers) easily navigate and find items that share similar attributes or purposes. Categories are typically organized in a hierarchy, allowing users to explore broad item types (e.g., “Electronics”) and then drill down into more specific subcategories (e.g., “Mobile Phones,” “Laptops”, etc.). By organizing items into categories, the online marketplace 112 enhances user experience, simplifies search, and improves the efficiency of browsing and filtering options. Further, categories enable the online marketplace 112 to deploy different user interfaces which include tailored digital content (e.g., digital images) at the category level, such as by deploying separately tailored user interface for an “Electronics” category, an “Automotive” category, a “Fashion” and/or “Luxury Goods” category, a “Sneakers” category, a “Collectibles” category, and so on.

As used herein a “title” refers to descriptive text input to a title field by a user (e.g., a seller) and used to identify and summarize an item listing. In some scenarios, a title may be generated or suggested by the online marketplace 112 based on other information input by a seller of an item, e.g., description, images, videos, shipping, availability, seasonality, and so on. The title is typically one of the first pieces of information a potential buyer sees and plays a crucial role in attracting attention and facilitating discovery through search results. A title may include relevant keywords, such as the item's brand, model, size, color, or key features, to ensure the listing is clear, informative, and optimized for search algorithms.

In order to meet the above discussed demand to provide relevant high-quality content for the ever-changing items of the online marketplace 112, the image generation and optimization system 106 can generate images for a particular category 122 without user interaction using titles 124 taken from listings 118 that are “live” within the particular category. In at least one implementation, the image generation and optimization system 106 generates such images using various multimodal large language models (LLMs) and generative artificial intelligence as discussed above and below.

In one or more implementations, the image generation and optimization system 106 includes sampling engine 126, large language model(s) 128, a large vision model 130, and a vision language model 132. It is to be appreciated that the image generation and optimization system 106 may include more, fewer, and/or different components in variations.

Broadly, the sampling engine 126 is configured to sample the titles 124 for the listings 118 in a particular category 122, e.g., so as to extract a subset of the titles for the listings in the particular category. In other words, the sampling engine 126 extracts or otherwise obtains a sample of listing titles 134 for a particular category 122. In one or more implementations, the sample of listing titles 134 corresponds to multiple strings of text (or title attributes), where each string of text is a title 124 of a respective listing 118.

The sampling engine 126 may process the listings 118 within a particular category 122 to sample the titles 124 in various ways in accordance with the described techniques. For example, the sampling engine 126 may receive one or more metrics for the listings 118 within a category 122, examples of which include but are not limited to click rates, views, and adds to cart, to name a few. Based on those received metrics, the sampling engine 126 may extract titles for a subset of the listings e.g., the titles of the top-k most popular listings according to click rates. Thus, in at least one implementation, the sampling engine 126 is configured to select listings with relatively high engagement (e.g., having a relatively high number of clicks and/or high click rate) to have their titles extracted. Alternatively, on in addition, the sampling engine 126 may obtain the sample of listing titles 134 using any of a variety of sampling algorithms or techniques, e.g. random sampling. The sampling engine 126 then provides the sample of listing titles 134 to the large language model(s) 128.

In one or more implementations, the large language model(s) 128 comprises a single LLM capable of simplifying each of the titles of the sample of listing titles 134 to generate the simplified listing titles 136 and also capable of generating an image prompt 138 based on the simplified listing titles 136, where the image prompt 138 is configured to elicit the large vision model 130 to generate multiple images 140 for the particular category. Alternatively, the large language model(s) 128 comprise multiple LLMs, such as a first LLM configured to simplify each of the titles in the sample of listing titles 134 to generate the simplified listing titles 136, and a second LLM configured to generate the image prompt 138 based on the simplified listing titles 136. Broadly, large language model(s) 128 are configured to generate output text from text input. By contrast, a large vision model 130 is configured to generate output images from text input. Further, the vision language model 132 is configured to generate text from any of text input, image input, and/or video input.

Returning to the discussion of the large language model(s) 128, as mentioned briefly above, the large language model(s) 128 are configured to simplify the sample of listing titles 134 to produce the simplified listing titles 136, in one or more implementations. By way of example and not limitation, the large language model(s) 128 may simplify titles by removing information that is extraneous for image generation, such as non-visual details of the listed item, e.g., brand names, sizing, shipping, item popularity, and so forth. Alternatively or additionally, the large language model(s) 128 may replace words in the title with semantically equivalent or similar words which are intended to be more likely to result in better images for the category.

Using the simplified listing titles 136, the large language model(s) 128 generate the image prompt 138. In at least one implementation, the large language model(s) 128 may also use the particular category, e.g., the text label or “name” for the particular category (“Electronics”), to generate the image prompt 138. The image prompt 138 is configured to elicit the large vision model 130 to generate multiple images 140 for the particular category. For example, the large language model(s) 128 analyzes the simplified listing titles 136 and a category name to generate a detailed, context-aware image prompt, which in at least one example specifies one or more subjects, style, and/or background of the desired images to be output by the large vision model 130, intended to ensure that those images accurately reflect the category's “essence.”

In one or more implementations, the large language model(s) 128 forms the image prompt 138, in part, by incorporating the simplified listing titles 136 into a prompt template 142. A prompt template 142 may include predefined prompt text and/or code that is useable along with additional information to instruct the large vision model 130 to generate images. For example, portions of the prompt template 142 may need to be “filled in,” e.g., with the simplified listing titles 136 and/or the particular category, before a prompt generated using the prompt template 142 is capable of actually eliciting relevant images from the large vision model 130. In at least one variation, the large language model(s) 128 generate the image prompt 138 for a particular category 122 using the simplified listing titles 136, but without using a prompt template.

Here, the prompt template 142 is depicted maintained in storage device 144 of the image generation and optimization system 106 along with predefined criteria 146. In one or more implementations, the storage device 144 is configured in a similar manner to the storage device 114 discussed above. In at least one implementation, the storage device 144 is included in or is part of the storage device 114.

Once generated, the image prompt 138 is then provided as input to the large vision model 130 to elicit the large vision model 130 to generate multiple images 140 for the particular category. This process replaces the need for human intervention and allows for scalable, automated image creation, such as at scheduled times (e.g., hourly, daily, etc.) and/or responsive to detectable triggers (e.g., some number of listings in the category having been added or removed potentially changing the category's composition). In accordance with the described techniques, the images 140 produced by the large vision model 130 are iteratively evaluated and regenerated until at least one of the images generated for the category is determined suitable for use, e.g., in a user interface of the online marketplace 112 for the particular category.

In accordance with the described techniques, the vision language model 132 is configured to evaluate the images 140 produced by the large vision model 130 to determine if any of those images are suitable for use. In one or more implementations, for instance, the vision language model 132 evaluates each of the multiple images 140 based on the predefined criteria 146. By way of example and not limitation, the predefined criteria 146 may include criteria such as fidelity to the image prompt 138, absence of image flaws, image quality (e.g., detail sharpness) and clarity, and adherence to a defined product photography style, to name a few. Fidelity to the image prompt 138 refers to a degree to which an image contains all the elements requested in the image prompt 138 and excludes any unintended elements. Absence of image flaws refers to absence of hallucinations and/or distortions in item or product shapes. Detail sharpness and clarity refers to the visibility, sharpness, and overall quality of image details. Adherence to product photography style refers to verifying that the image follows stylistic guidelines (which can also be maintained as text and/or one or more example images in the storage device 144), examples of which include focused subjects, simple backgrounds, and/or lighting having defined characteristics. It is to be appreciated that in variations, the vision language model 132 evaluates the images 140 relative to different criteria to determine whether any of the images are suitable.

In at least one implementation, the vision language model 132 may evaluate each of the multiple images 140 in relation to each of the predefined criteria 146. For instance, the vision language model 132 may produce score(s) 148, which reflect how well or not an image satisfies each of the predefined criteria 146. In one example, for an individual image of the multiple images 140, the vision language model 132 assigns a score 148 (e.g., a numerical score from 1-10) for each criterion of the predefined criteria 146. Those component scores can then be added up to produce a total score. If the score(s) 148 satisfy a threshold score, then the image may be determined useable and it may be output, e.g., automatically incorporated into a user interface of the online marketplace 112 for the category.

However, if the score(s) 148 (e.g., one of the component scores and/or the total score) fail to satisfy the threshold score and/or component threshold scores, then the vision language model 132 is configured to refine the image prompt 138 to produce the refined image prompt 150. The refined image prompt 150 is configured to elicit the large vision model 130 to regenerate the multiple images 140 for the particular category. In one or more implementations, to refine the image prompt 138 and produce the refined image prompt 150, the vision language model 132 analyzes the images 140, the image prompt 138, and the results of the evaluation (e.g., the score(s) 148), and modifies the text and/or code of the previously used image prompt. This multimodal-based evaluation and iterative optimization of both the multiple images 140 and the image prompt 138 (and the refined image prompt 150 in subsequent iterations) continues until an image satisfying the threshold score is produced. In this way, the recursive improvement cycle allows for the generation of highly optimized, contextually relevant images.

Having considered an example of an environment, consider now a discussion of some example details of the techniques for automated image generation and optimization in accordance with one or more implementations.

### Implementation Details

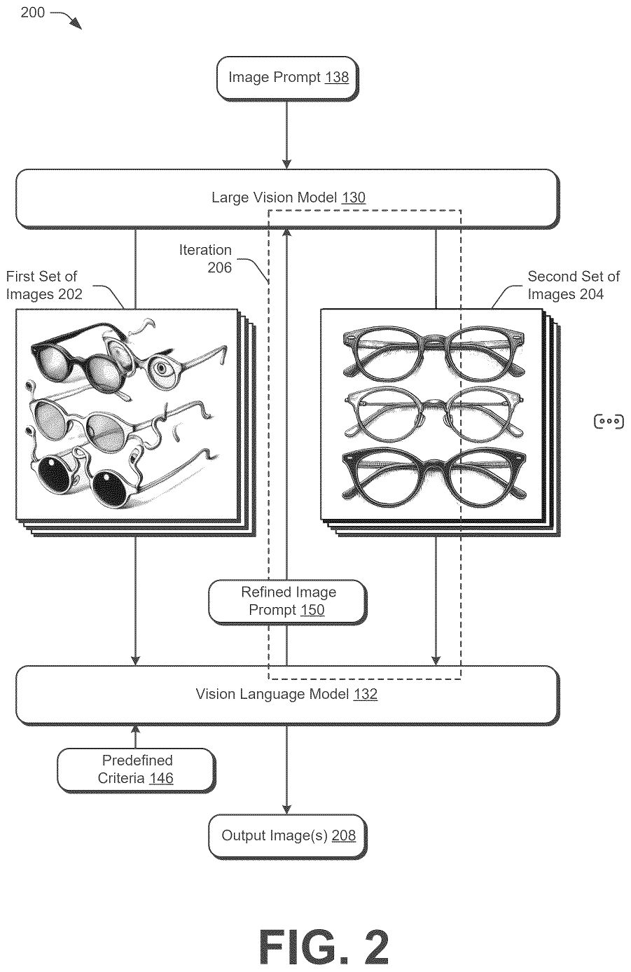

FIG. 2 depicts an example 200 of using a vision language model to iteratively evaluate generated images against predefined criteria and refine an image prompt to regenerate and improve the images.

This example 200 depicts the initial image prompt 138 being provided to a large vision model 130. The large vision model 130 generates a first set of images 202 based on the prompt. These images are then evaluated by the vision language model 132 according to the predefined criteria 146. In particular, the vision language model 132 assesses each image in the first set of images 202 against the predefined criteria 146, which may include factors such as image quality, lack of flaws (e.g., hallucinations and/or distortions), adherence to the prompt, and consistency with product photography standards.

If none of the images in the first set of images 202 meets a threshold score based on the evaluation, the image generation and optimization system 106 performs an iteration 206 of prompt refining and image regenerating. During this iteration 206, the vision language model 132 generates a refined image prompt 150. This refined prompt may incorporate insights gained from the evaluation of the first set of images 202, aiming to address any shortcomings identified.

The refined image prompt 150 is then fed back to the large vision model 130, which generates a second set of images 204. The vision language model 132 evaluates this second set of images 204 against the same predefined criteria 146. If any of the images in this set meet the threshold score, they may be designated as output image(s) 208. However, if none of the images in the second set of images 204 meets the threshold, the image generation and optimization system 106 may continue through additional iterations. Each iteration involves refining the image prompt based on the evaluation results, generating a new set of images, and re-evaluating those images.

This iterative process may continue until at least one image meets the threshold score based on the predefined criteria. The number of iterations may vary depending on the complexity of the category, the specificity of the criteria, and the performance of the collection of multimodal large language models. In some implementations, the system may set a maximum number of iterations to ensure the process does not continue indefinitely. If this limit is reached without producing a satisfactory image, the system may either select the best image generated so far or trigger a different process, such as manual intervention or the use of a different image generation technique.

The example 200 demonstrates how the large vision model 130 and vision language model 132 work in tandem to progressively refine and improve the generated images. This iterative approach may allow the system to adapt to challenging categories or criteria, potentially producing higher quality and more relevant images for use in the online marketplace.

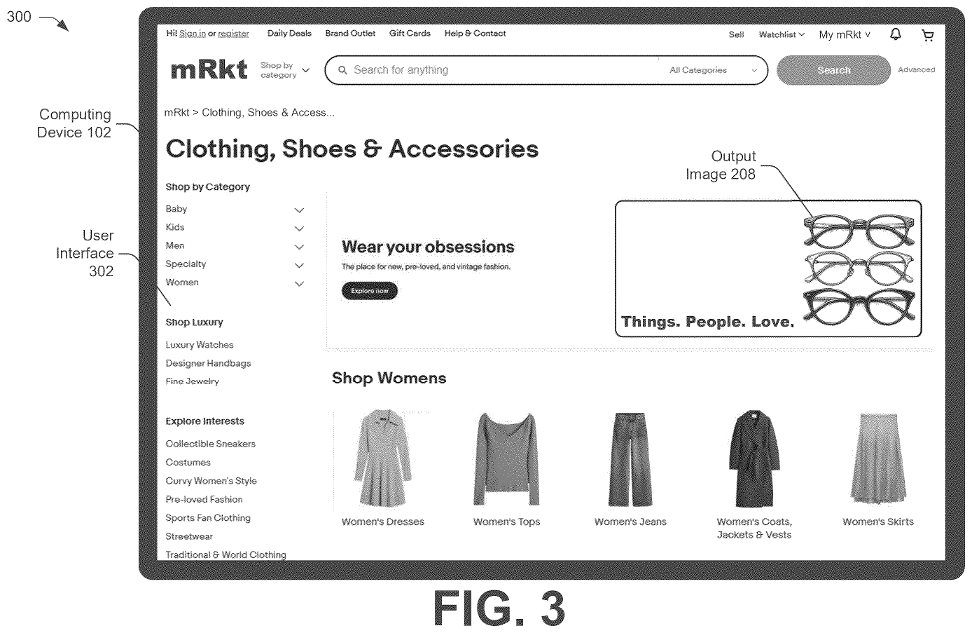

FIG. 3 depicts an example 300 of a user interface that incorporates an image generated by a large vision model where the incorporated image satisfies a threshold score for the predefined criteria.

In this example 300, a category interface 302 (e.g., for “Clothing, Shoes & Accessories”) of the online marketplace 112 is displayed on a display device of a computing device 102. The category interface 302 includes various navigation elements and indications of sub-categories of the higher-level category. Within the category interface 302, an output image 208 is prominently displayed. This output image 208 represents a high-quality, AI-generated image that has met or exceeded the threshold score based on the predefined criteria 146, as evaluated by the vision language model 132.

The incorporation of the output image 208 into the category interface 302 demonstrates one way in which the images produced by the described techniques may be utilized. In this case, the image serves as a visual representation for the category, potentially enhancing user engagement and providing a clear, professional depiction of products within that category.

In addition to the implementation shown in FIG. 3, images produced using the described techniques and collection of multimodal large language models may be utilized in various other ways. For example, images output by the image generation and optimization system 106 may be used for product listing enhancements, such that generated images may be used to supplement or replace low-quality user-submitted photos in individual product listings, potentially improving the overall visual appeal and consistency of the marketplace. Additionally, or alternatively, images output by the image generation and optimization system 106 may be used for marketing materials, enabling high-quality, artificial intelligence (AI)-generated images to be incorporated into email campaigns, social media posts, and/or banner advertisements to promote specific categories or products. Additionally, or alternatively, images output by the image generation and optimization system 106 may be used for mobile app interfaces, such that the images may be integrated into mobile application interfaces, serving as category icons or featured content in app-specific layouts. Additionally, or alternatively, images output by the image generation and optimization system 106 may be used for search result thumbnails, such that when users perform searches, the generated images may be used as representative thumbnails for categories or groups of similar products in the search results. Additionally, or alternatively, images output by the image generation and optimization system 106 may be used for personalized recommendations, such that the system may generate and display custom images based on a user's browsing history or preferences, creating visually appealing product suggestions. Additionally, or alternatively, images output by the image generation and optimization system 106 may be used for virtual try-on experiences, such that for categories like eyewear or clothing, the generated images may be adapted for use in virtual try-on features, allowing users to visualize products on themselves. Additionally, or alternatively, images output by the image generation and optimization system 106 may be used for seasonal or themed collections, such that the image generation system may produce themed sets of images for special events, holidays, or seasonal promotions, which can be used across various sections of the online marketplace 112. Additionally, or alternatively, images output by the image generation and optimization system 106 may be used for dynamic category banners, such that the system may generate and update category banner images in real-time based on current trends or popular items within each category. Additionally, or alternatively, images output by the image generation and optimization system 106 may be used for visual navigation aids, such that the generated images may be used to create visual hierarchies or maps of product categories, helping users navigate complex category structures more intuitively. Additionally, or alternatively, images output by the image generation and optimization system 106 may be used for seller tools, such that the system may provide sellers with AI-generated lifestyle or context images to enhance their product listings, especially for sellers who may not have access to professional photography resources.

Having discussed exemplary details of automated image generation and optimization, consider now some examples of procedures to illustrate additional aspects of the techniques.

### Example Procedures

This section describes examples of procedures for automated image generation and optimization. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

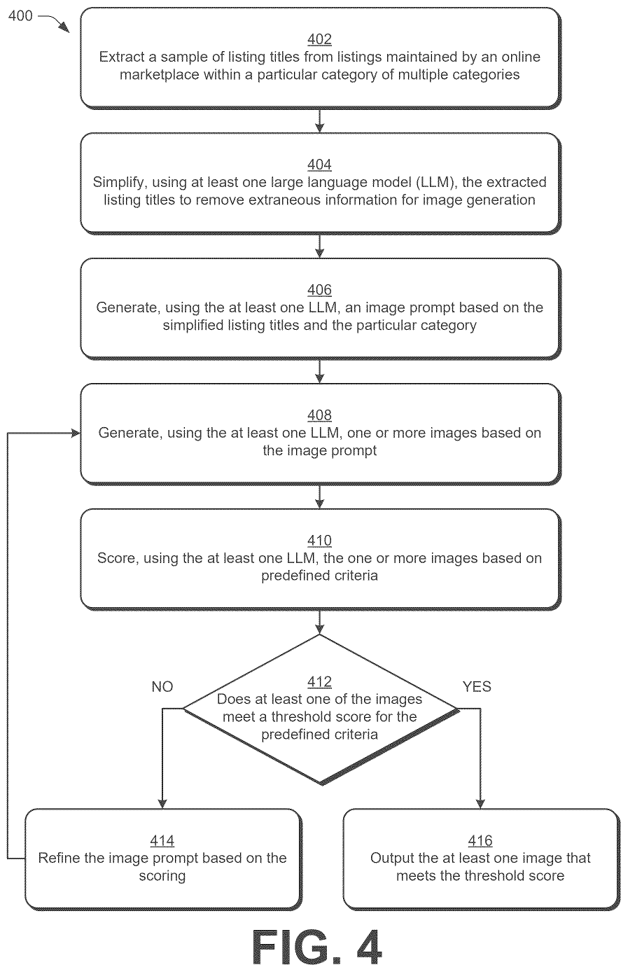

FIG. 4 depicts a procedure 400 in an example implementation of automated image generation and optimization.

A sample of listing titles is extracted from listings maintained by an online marketplace within a particular category of multiple categories (block 402). By way of example, the sampling engine 126 extracts a sample of listing titles 134 from the listings 118 which correspond to a particular category 122 of the multiple categories defined for the online marketplace 112.

The extracted listing titles are simplified using at least one large language model (LLM) to remove extraneous information for image generation (block 404). By way of example, the large language model(s) 128 may process the sample of listing titles 134 to generate simplified listing titles 136, removing extraneous information, examples of which include non-visual details such as brand names, sizing information, or other extraneous text not directly relevant to image generation.

An image prompt is generated using the at least one LLM based on the simplified listing titles and the particular category (block 406). For instance, the large language model(s) 128 may analyze the simplified listing titles 136 along with the particular category 122 to create an image prompt 138 that captures the essential visual elements and style appropriate for that category.

One or more images are generated using the at least one LLM based on the image prompt (block 408). By way of example, the large vision model 130 may receive the image prompt 138 and produce multiple images 140 that visually represent the content described in the prompt.

The one or more images are scored using the at least one LLM based on predefined criteria (block 410). For example, the vision language model 132 may evaluate each of the multiple images 140 against the predefined criteria 146, generating score(s) 148 that reflect how well each image meets the specified quality standards and prompt requirements.

A determination is made as to whether at least one of the images meets a threshold score for the predefined criteria (block 412). The image generation and optimization system 106 may compare the score(s) 148 to a predetermined threshold to make this determination.

If none of the images meet the threshold score, the image prompt is refined based on the scoring (block 414), e.g., “NO” at block 412. In this scenario, the vision language model 132 may analyze the evaluation results and generate a refined image prompt 150, incorporating insights from the previous iteration to address identified shortcomings in the generated images. If at least one of the images meets the threshold score, the at least one image that meets the threshold score is output (block 416), e.g., “YES” at block 412. By way of example, at least one of the output image(s) 208 is incorporated into a respective user interface of the category for which the images were generated according to the above-described procedure 400. Alternatively, or additionally, at least one of the output image(s) 208 is stored in the storage device 144 and/or the storage device 114.

Having described examples of procedures in accordance with one or more implementations, consider now an example of a system and device that can be utilized to implement the various techniques described herein.

### Example System and Device

FIG. 5 illustrates an example of a system generally at 500 that includes an example of a computing device 502 that is representative of one or more computing systems and/or devices that may implement the various techniques described herein. This is illustrated through inclusion of the application 110 and the image generation and optimization system 106. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 506 is illustrated as including memory/storage 512. The memory/storage 512 represents memory/storage capacity associated with one or more computer-readable media. The memory/storage 512 may include volatile media (such as random-access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device embodiment, implementation of functionality described herein may be distributed throughout the system 500. For example, the functionality may be implemented in part on the computing device 502 as well as via the platform 516 that abstracts the functionality of the cloud 514.

In some aspects, the techniques described herein relate to a computer-implemented method including: extracting, by one or more processors, a sample of listing titles from listings maintained by an online marketplace within a particular category of a plurality of categories; simplifying, by the one or more processors using at least one large language model (LLM), the extracted listing titles to remove extraneous information for image generation; generating, by the one or more processors using the at least one LLM, an image prompt based on the simplified listing titles and the particular category; generating, by the one or more processors using the at least one LLM, one or more images based on the image prompt; scoring, by the one or more processors using the at least one LLM, the one or more images based on predefined criteria; and iteratively refining, by the one or more processors, the image prompt based on the scoring, and regenerating images until at least one image meets a threshold score for the predefined criteria.

In some aspects, the techniques described herein relate to a computer-implemented method, wherein the at least one large language model includes a large vision model, the large vision model generating the one or more images based on the image prompt and regenerating the images based on one or more iteratively refined image prompts.

In some aspects, the techniques described herein relate to a computer-implemented method, wherein the at least one large language model includes a vision language module, the vision language model scoring the one or more images based on the predefined criteria and iteratively refining the image prompt.

In some aspects, the techniques described herein relate to a computer-implemented method, wherein extracting the sample of listing titles includes selecting the listing titles from listings with a higher engagement rate within the particular category.

In some aspects, the techniques described herein relate to a computer-implemented method, wherein simplifying the extracted listing titles includes removing at least one of brand names, size information, or model numbers.

In some aspects, the techniques described herein relate to a computer-implemented method, wherein generating the image prompt includes specifying a subject, style, and background for the image.

In some aspects, the techniques described herein relate to a computer-implemented method, wherein generating the one or more images includes creating multiple images for each image prompt.

In some aspects, the techniques described herein relate to a computer-implemented method, wherein the predefined criteria for scoring the generated images include at least one of: correspondence to the image prompt; absence of image flaws; image quality and clarity; or consistency with a product photography style.

In some aspects, the techniques described herein relate to a computer-implemented method, wherein scoring the generated images includes assigning a numerical score for each of the predefined criteria.

In some aspects, the techniques described herein relate to a computer-implemented method, further including incorporating the at least one image that meets the threshold score into a user interface corresponding to the particular category in the online marketplace.

In some aspects, the techniques described herein relate to a system including: one or more processors; and memory storing instructions that, when executed by the one or more processors, cause the system to perform operations including: extracting a sample of listing titles from listings maintained by an online marketplace within a particular category of a plurality of categories; simplifying, using at least one large language model (LLM), the extracted listing titles to remove extraneous information for image generation; generating, using the at least one LLM, an image prompt based on the simplified listing titles and the particular category; generating, using the at least one LLM, one or more images based on the image prompt; scoring, using the at least one LLM, the one or more images based on predefined criteria; and iteratively refining the image prompt based on the scoring, and regenerating images until at least one image meets a threshold score for the predefined criteria.

In some aspects, the techniques described herein relate to a system, wherein the at least one large language model includes a large vision model and a vision language model, the large vision model generating the one or more images based on the image prompt, and the vision language model scoring the one or more images based on the predefined criteria and iteratively refining the image prompt.

In some aspects, the techniques described herein relate to a system, wherein the operations further include incorporating the at least one image that meets the threshold score into a user interface corresponding to the particular category in the online marketplace.

In some aspects, the techniques described herein relate to a system, wherein simplifying the extracted listing titles includes replacing words in the titles with semantically equivalent words that are more likely to result in better images for the category.

In some aspects, the techniques described herein relate to one or more non-transitory computer-readable media storing instructions that, when executed by one or more processors, cause the one or more processors to perform operations including: extracting a sample of listing titles from listings maintained by an online marketplace within a particular category of a plurality of categories; simplifying, using at least one large language model (LLM), the extracted listing titles to remove extraneous information for image generation; generating, using the at least one LLM, an image prompt based on the simplified listing titles and the particular category; generating, using the at least one LLM, one or more images based on the image prompt; scoring, using the at least one LLM, the one or more images based on predefined criteria; and iteratively refining the image prompt based on the scoring, and regenerating images until at least one image meets a threshold score for the predefined criteria.

In some aspects, the techniques described herein relate to one or more non-transitory computer-readable media, wherein the operations further include selecting high-engagement listings within the particular category for extracting the sample of listing titles.

In some aspects, the techniques described herein relate to one or more non-transitory computer-readable media, wherein generating the image prompt includes incorporating the simplified listing titles into a prompt template.

In some aspects, the techniques described herein relate to one or more non-transitory computer-readable media, wherein the predefined criteria for scoring the generated images include absence of distortions in product shapes.

In some aspects, the techniques described herein relate to one or more non-transitory computer-readable media, wherein iteratively refining the image prompt includes analyzing evaluation results from a previous iteration to address identified shortcomings in the generated images.

In some aspects, the techniques described herein relate to one or more non-transitory computer-readable media, wherein the operations further include setting a maximum number of iterations for refining the image prompt and regenerating images.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
extracting a sample of listing titles from listings maintained by an online marketplace within a particular category of a plurality of categories;
simplifying, using at least one large language model (LLM), the extracted listing titles to remove extraneous information for image generation;
generating, using the at least one LLM, an image prompt based on the simplified listing titles and the particular category;
generating, using the at least one LLM, one or more images based on the image prompt;
scoring, using the at least one LLM, the one or more images based on predefined criteria; and
iteratively refining the image prompt based on the scoring, and regenerating images until at least one image meets a threshold score for the predefined criteria.

2. The computer-implemented method of claim 1, wherein the at least one large language model includes a large vision model, the large vision model generating the one or more images based on the image prompt and regenerating the images based on one or more iteratively refined image prompts.

3. The computer-implemented method of claim 1, wherein the at least one large language model includes a vision language module, the vision language model scoring the one or more images based on the predefined criteria and iteratively refining the image prompt.

4. The computer-implemented method of claim 1, wherein extracting the sample of listing titles comprises selecting the listing titles from listings with a higher engagement rate within the particular category.

5. The computer-implemented method of claim 1, wherein simplifying the extracted listing titles comprises removing at least one of brand names, size information, or model numbers.

6. The computer-implemented method of claim 1, wherein generating the image prompt comprises specifying a subject, style, and background for the image.

7. The computer-implemented method of claim 1, wherein generating the one or more images comprises creating multiple images for each image prompt.

8. The computer-implemented method of claim 1, wherein the predefined criteria for scoring the generated images include at least one of:
correspondence to the image prompt;
absence of image flaws;
image quality and clarity; or
consistency with a product photography style.

9. The computer-implemented method of claim 8, wherein scoring the generated images comprises assigning a numerical score for each of the predefined criteria.

10. The computer-implemented method of claim 1, further comprising incorporating the at least one image that meets the threshold score into a user interface corresponding to the particular category in the online marketplace.

11. A system comprising:
one or more processors; and
memory storing instructions that, when executed by the one or more processors, cause the system to perform operations comprising:
extracting a sample of listing titles from listings maintained by an online marketplace within a particular category of a plurality of categories;
simplifying, using at least one large language model (LLM), the extracted listing titles to remove extraneous information for image generation;
generating, using the at least one LLM, an image prompt based on the simplified listing titles and the particular category;
generating, using the at least one LLM, one or more images based on the image prompt;
scoring, using the at least one LLM, the one or more images based on predefined criteria; and
iteratively refining the image prompt based on the scoring, and regenerating images until at least one image meets a threshold score for the predefined criteria.

12. The system of claim 11, wherein the at least one large language model includes a large vision model and a vision language model, the large vision model generating the one or more images based on the image prompt, and the vision language model scoring the one or more images based on the predefined criteria and iteratively refining the image prompt.

13. The system of claim 11, wherein the operations further comprise incorporating the at least one image that meets the threshold score into a user interface corresponding to the particular category in the online marketplace.

14. The system of claim 11, wherein simplifying the extracted listing titles comprises replacing words in the titles with semantically equivalent words that are more likely to result in better images for the category.

15. One or more non-transitory computer-readable media storing instructions that, when executed by one or more processors, cause the one or more processors to perform operations comprising:
extracting a sample of listing titles from listings maintained by an online marketplace within a particular category of a plurality of categories;
simplifying, using at least one large language model (LLM), the extracted listing titles to remove extraneous information for image generation;
generating, using the at least one LLM, an image prompt based on the simplified listing titles and the particular category;
generating, using the at least one LLM, one or more images based on the image prompt;
scoring, using the at least one LLM, the one or more images based on predefined criteria; and
iteratively refining the image prompt based on the scoring, and regenerating images until at least one image meets a threshold score for the predefined criteria.

16. The one or more non-transitory computer-readable media of claim 15, wherein the operations further comprise selecting high-engagement listings within the particular category for extracting the sample of listing titles.

17. The one or more non-transitory computer-readable media of claim 15, wherein generating the image prompt comprises incorporating the simplified listing titles into a prompt template.

18. The one or more non-transitory computer-readable media of claim 15, wherein the predefined criteria for scoring the generated images include absence of distortions in product shapes.

19. The one or more non-transitory computer-readable media of claim 15, wherein iteratively refining the image prompt comprises analyzing evaluation results from a previous iteration to address identified shortcomings in the generated images.

20. The one or more non-transitory computer-readable media of claim 15, wherein the operations further comprise setting a maximum number of iterations for refining the image prompt and regenerating images.
